(19) United States
(12) Patent Application Publication
(10) Pub. No.: US 2010/0024977 A1
(43) Pub. Date: Feb. 4, 2010

(54) Method for Applying Polymeric Adhesive as Adhesive Agent to Bond Wood or Garnish

(76) Inventor: Shouhui Zhu, Guangdong (CN)

Correspondence Address: RUDOLPH J. BUCHEL JR., LAW OFFICE OF, P. O. BOX 702526, DALLAS, TX, 75370-2526, US

(21) Appl. No.: 11/887,694

(22) PCT Filed: Nov. 18, 2005
(86) PCT No.: PCT/CN2005/001957

§ 371 Date: Oct. 1, 2007

(30) Foreign Application Priority Data
Mar. 31, 2005 (CN) 200510033796.1

(51) Int. Cl. C09J 103/04

(52) U.S. Cl. 156/328

(57) ABSTRACT

The present application discloses a method for applying polymeric adhesive as adhesive agent to bond wood article or garnish, the polymeric adhesive comprises starch and polymeric macromolecule or adhesive containing the polymeric macromolecule, the method includes: modifying the starch and polymeric macromolecule, graft polymrerizing the modified starch and polymeric macromolecule in a container at 20-100 to producing the polymeric adhesive. The method may bond all kinds of wood articles together, such as wood furniture, wood furniture, cabinet, plywood, lumbercore plywood, density board, flake board, etc., it also can be used as inner wall coating, lacquer putty, for bonding the inner wall tile, wallpaper, wall covering, garnish paster, carpet, leather. When dipped in the water for 48 hours or boiled in the water at 63 for 3 hours, the bonded article does not crack. The shear strength dry strength of the standard sample may be up to 5-14 mPa, the green strength can teach to 2-7 mPa.

### BACKGROUND OF THE INVENTION

1) Field of the Invention

This invention relates to an industrial adhesive, particularly relates to a method for adhering woody product with amylum and polymeric macromolecule material as adhesive.

2) Description of Prior Art

In the present art, adhesive made from amylum is usually used for adhering paper product, so, its viscidity is poor that is difficult to adhere product requiring higher viscidity, such as woody product of furniture.

### SUMMARY OF THE INVENTION

Objective of this invention is to provide a method for adhering woody product with amylum and polymeric macromolecule material as adhesive so as to overcome disadvantage in current art, said method can improve adhesive strength of woody product so far.

This invention is to provide a method for adhering woody product or adornment with polymeric adhesive as adhesive, wherein polymeric adhesive is composed of amylum and polymeric macromolecule material, the method to prepare adhesive includes following steps: first modify amylum and polymeric macromolecule material, then put such modified amylum and polymeric macromolecule material into vessel under 20°-100° C., but the best temperature is 45-65° C., for graft polymerization so as to prepare polymeric adhesive and steps to further modify amylum are as follows:

(1) Oxidative modification of amylum: the purpose is to oxidize parts of OH in amylum molecule into COOH, it is allowed to oxidize it on group of C₂-C₆ by selection, oxidation is done in alkali amylum liquor with 6-14 PH values, dosage of oxidant is 0.8%-10%, and temperature of alkali liquor is 30° C.-70° C., wherein aldehyde group is corrosion resistant and carboxyl can strengthen adhesive strength of wood fiber;

(2) Pasted modification of amylum: it is done in alkali liquor. As a matter of fact, pasting is to modify the surplus OH in amylum molecule after oxidation; the method is to keep adding proper alkali liquor so that OH in amylum molecule become St-ONa, at this moment, glue in the reaction system become thick, viscidity is increased thereof; besides, alkali liquor is added at rate of 1-15%, or PH values are between 7 and 20;

(3) Ether modification of amylum indicates that certain hydroxyl in amylum molecule is combined into another type of amylum derivative with one hydroxyl in hydroxyl compound through oxygen atom; modifying agent added during ether modification is of acid or epoxy chloropropane; acid or epoxy chloropropane in glue under temperature of 30° C. -90° C., but the best temperature is 50° C.-65° C., reacts with amylum to produce ether amylum derivative, and acid or epoxy chloropropane is added at rate of 1-15%, so that its viscidity and tenacity will be promoted, it is eligible for corrosion resistance, water resistance and adhesive strength are also strengthened so far; (4) Cross-linking modification: carbamide added in glue is able to crosslink amylum molecule, in glue at temperature of 40° C. -85° C., but the best temperature is 50° C. -65° C., carbamide shrinks with aldehyde group in amylum molecule or aldehyde produced during oxidation to produce certain high polymer, carbamide is added at rate of 1-10% that improves viscidity and strength of glue;

Above said polymeric macromolecule modification also include following steps: emulsify and copolymerize the dissolved PVA or PVAC, namely, decrease temperature of the dissolved PVA or PVAC to 50° C. -120° C., but the best temperature is 60° C. -80° C., then, add emulsifying agent and initiating agent to emulsify or copolymerize it with proper VAC or PA, so that the linked PVA colloid produces scattered particle latex to reduce viscidity but speed up fluidity. Volumes of initiating agent and VAC are 1-15% and 3-15% respectively;

Furthermore, following steps are also included for graft polymerization of above modified amylum and polymeric macromolecule: polymerize the modified amylum and polymeric macromolecule material in vessel at 20° C.-100° C., but the best temperature is 50° C.-65° C., to produce high quality natural plant amylum adhesive. Steps to adhere woody product with the prepared adhesive as described above are as follows:

coat above described adhesive on surface of two pieces of woody product at temperature of −10° C. -50° C., and then press down another surface of two pieces of woody product at pressure of 5 kg, it takes 5-25min to air under normal temperature and gets hardened within 24 h. Said adhesive can adhere any kind of woody product; product adhered with adhesive in accordance with this invention will not crack even soaked in water for 48 h and boiled in water of 63° C. for 3 h, shear and dry strength of standard sample can reach 5-14 MPa, its wet strength is 2-7 MPa.

Above said woody product is one of following products: woody furniture, fabric furniture, kitchen furniture, veneer, density fiber board, flakeboard;

Above said adornment includes one of following products: internal wall paint, paint stucco, internal wall ceramic tiles, wall paper, wall cloth, carpet and leather;

Above said adhesive is also applicable to correction liquor.

Method of the invention can adhere any kind of woody product, such as woody furniture, fabric furniture, kitchen furniture, veneer, density fiber board, flakeboard; product adhered with adhesive in accordance with this invention will not crack even soaked in water for 48 h and boiled in water of 63° C. for 3 h, shear and dry strength of standard sample can reach 5-14 MPa, its wet strength is 2-7 MPa, besides, it is also applicable to internal wall paint, paint stucco, internal wall ceramic tiles, wall paper, wall cloth, carpet and leather;

### DESCRIPTION OF THE PREFERRED EMBODIMENT

This invention provides a method for adhering woody product or adornment with polymeric adhesive as adhesive, wherein polymeric adhesive is composed of amylum and polymeric macromolecule material, the method to prepare adhesive includes following steps: first modify amylum and polymeric macromolecule material; then put such modified amylum and polymeric macromolecule material into vessel under 40°-80° C. for graft polymerization so as to prepare polymeric adhesive, amylum is modified in three-level steps as follows:

One or two or three steps of following three-level steps can be used for modification, it is allowed to use one or several steps according to purpose or situation using adhesive, if no serious requirement for viscidity strength, one or two steps can be used for modification, if the requirement is serious, the three-level steps shall be used for modification, sequence of said three-level modification step is changeable, and now, the operating flow of said three-level modification steps are described as follows:

Principle of three-level modification steps is that C₁- C₆ in amylum molecule can produce different chemical reaction on group, it is measured that hydroxide in C₂,C₃ and C₆ can produce chemical reaction, this is why amylum molecule can be modified, a known amylum molecule contents 600-6000 dextrose molecule, the modified amylum glue prepared with single method is a modified and non-modified mixed amylum glue; thus, we can confirm that the surplus original amylum modified with single method can be modified further by adding other agents, this is the foundation and background of three-level modification theory.

(1) Oxidative modification of amylum: the purpose is to oxidize parts of OH in amylum molecule into COOH, it is allowed to oxidize it on group of C₂- C₆ by selection, oxidation is done in alkali amylum liquor with 6-14 PH values, dosage of oxidant is 0.8%-10%, and temperature of alkali amylum liquor is 30° C. -100° C., but the best temperature is 40° C.-55° C., wherein aldehyde group is corrosion resistant and carboxyl can strengthen adhesive strength of wood fiber;

(2) Pasted modification of amylum: it is done in alkali liquor. As a matter of fact, pasting is to modify the surplus OH in amylum molecule after oxidation; the method is to keep adding proper alkali amylum liquor so that OH in amylum molecule become St-ONa, at this moment, glue in the reaction system become thick, viscidity is increased thereof; besides, alkali liquor is added at rate of 1-15%; or PH values reach 7-20, temperature of alkali atnylum liquor is 30° C.- 100° C., but the best temperature is 50° C.-65° C.;

(3) Ether modification of amylum indicates that certain hydroxyl in amylum molecule is combined into another type of amylum derivative with one hydroxyl in hydroxyl compound through oxygen atom; modifying agent added during ether modification is of acid or epoxy chloropropane; acid or epoxy chloropropane in glue under temperature of 30° C.-70° C. reacts with amylum to produce ether amylum derivative, and acid or epoxy chloropropane is added at rate of 1-15%, so that its viscidity and tenacity will be promoted, it is eligible for corrosion resistance, water resistance and adhesive strength arc also strengthened so far.

(4) Cross-linking modification: carbamide added in glue is able to crosslink amylum molecule, in glue at temperature of 40° C.-85° C., but the best temperature is 50° C.-65° C., carbamide shrinks with aldehyde group in amylum molecule or aldehyde produced during oxidation to produce certain high polymer, carbamide is added at rate of 1-10% that improves viscidity and strength of glue;

above said polymeric macromolecule modification also include following steps: emulsify and copolymerize the dissolved PVA or PVAC, namely, decrease temperature of the dissolved PVA or PVAC to 50° C. -100° C., but the best temperature is 65° C.-85° C., then, add emulsifying agent and initiating agent to emulsify or copolymerize it with proper VAC or PA, so that the linked PVA colloid produces scattered particle latex to reduce viscidity but speed up fluidity. Volumes of initiating agent and VAC are 1-15% and 3-15% respectively;

Furthermore, following steps are also included for graft polymerization of above modified amylum and polymeric macromolecule: polymerize the modified amylum and polymeric macromolecule material in vessel at 20° C.-100° C., but the best temperature is 45° C.-65° C., to produce high quality natural plant amylum adhesive. Steps to adhere woody product with the prepared adhesive as described above are as follows:

coat above described adhesive on surface of two pieces of woody product at temperature of −10° C. -50° C., then press down another surface of two pieces of woody product at pressure of 5 kg, it takes 5-25 min to air under normal temperature and gets hardened within 24 h. Said adhesive can adhere any kind of woody product, product adhered with adhesive in accordance with this invention will not crack even soaked in water for 48 h and boiled in water of 63° C. for 3 h, shear and dry strength of standard sample can reach 5-14 MPa, its wet strength is 2-7 MPa.

Said adhesive is workable under temperature of −10-50° C., which can be aired at normal temperature between 5 and 25 min and get hardened within 24 h, it can adhere any kind of woody product by pressing down at pressure of over 5 kg according to the standard sample, such as woody furniture, fabric furniture, kitchen furniture, veneer, density fiber board, flakeboard, besides, product adhered with adhesive in accordance with this invention will not crack even soaked in water for 48 h and boiled in water of 63° C. for 3 h, shear and dry strength of standard sample can reach 5-14 MPa, its wet strength is 2-7 MPa, besides, it is also applicable to internal wall paint, paint stucco, internal wall ceramic tiles, wall paper, wall cloth, carpet and leather.

What is claimed is:

1. A method for adhering woody product or adornment using polymeric adhesive as adhesive, wherein polymeric adhesive is composed of amylum and polymeric macromolecule material, the method to prepare adhesive includes following steps: first modify amylum and polymeric macromolecule material, then put such modified amylum and polymeric macromolecule material into vessel at 20° -100° C., but the best temperature of 50° C.-65° C. for graft polymerization so as to prepare polymeric adhesive, and steps to modify amylum are as follows:
Oxidative modification of amylum: the purpose is to oxidize parts of OH in amylum molecule into COOH, it is allowed to oxidize it on group of C₂-C₆ by selection, oxidation is done in alkali amylum liquor with 6-14 PH values, dosage of oxidant is 0.8%-10%, and temperature of alkali amylum liquor is 30° C.-100° C., but the best temperature is 40° C.-55° C., aldehyde group is corrosion resistant and carboxyl can strengthen adhesive strength of wood fiber;
Steps to adhere woody product with the prepared adhesive as described above are as follows:
coat above described adhesive on surface of two pieces of woody product at temperature of −10° C. -50° C., and then press down another surface of two pieces of woody product at pressure of 5 kg, it takes 5-25min to air under normal temperature and gets hardened within 24 h. Said adhesive can adhere any kind of woody product;
product adhered with adhesive in accordance with this invention will not crack even soaked in water for 48 h and boiled in water of 63° C. for 3 h, shear and dry strength of standard sample can reach 5-14 MPa, its wet strength is 2-7 MPa.

2. The method of claim 1 wherein said woody product is one of following products: woody furniture, fabric furniture, kitchen furniture, veneer, density fiber board, flakeboard;

3. The method of claim 1 wherein said adornment is one of following products: internal wall paint, paint stucco, internal wall ceramic tiles, wall paper, wall cloth, carpet and leather;

4. The method of claim 1 where said amylum modification steps are as follows:
undertake pasted modification on amylum liquor after oxidative modification, it is done in alkali liquor. As u matter of fact, pasting is to modify the surplus OH in amylum molecule after oxidation; the method is to keep adding proper alkali liquor so that OH in amylum molecule become St-ONa, at this moment, glue in the reaction system become thick, viscidity is increased thereof; besides, alkali liquor is added at rate of 1-15%, or PH value is between 7 and 20, temperature of alkali amylum liquor is 30° C.-100° C., but the best temperature is 50° C.-65° C.

5. The method of claim 4 wherein said amylum modification steps further include following steps:
Ether modification of amylum after pasted modification indicates that certain hydroxyl in amylum molecule is combined into another type of amylum derivative with one hydroxyl in hydroxyl compound through oxygen atom; modifying agent added during ether modification is of acid or epoxy chloropropane; acid or epoxy chloropropane in glue at temperature of 30° C.-90° C., but the best temperature is 50° C.-65° C., reacts with amylum to produce ether amylum derivative, and acid or epoxy chloropropane is added at rate of 1-15%, so that its viscidity and tenacity will be promoted, it is eligible for corrosion resistance, water resistance and adhesive strength are also strengthened so far.
To have cross-linking modification on amylum after ether modification, carbamide added in glue is able to crosslink amylum molecule, in glue at temperature of 40° C.-85° C., but the best temperature is 50° C.-65° C., carbamide shrinks with aldehyde group in amylum molecule or aldehyde produced during oxidation to produce certain high polymer, carbamide is added at rate of 1-10% that improves viscidity and strength of glue;

6. The method of claim 1 wherein said polymeric macromolecule modification also include following steps: emulsify and copolymerize the dissolved PVA or PVAC, namely, decrease temperature of the dissolved PVA or PVAC to 50° C.-90° C., but the best temperature is 65° C.-80° C., then, add emulsifying agent and initiating agent to emulsify or copolymerize it with proper VAC or PA, so that the linked PVA colloid produces scattered particle latex to reduce viscidity but speed up fluidity. Volumes of initiating agent and VAC are 1-15% and 3-15% respectively;

7. The method of claim 1 wherein said following steps are also included for graft polymerization of modified amylum and polymeric macromolecule material: Polymerize the modified amylum and polymeric macromolecule material in vessel at temperature of 20° C.-100° C. , but the best temperature is 60° C.-80° C. to produce high quality natural plant amylum adhesive.
